(19) United States
(12) Patent Application Publication
(10) Pub. No.: US 2011/0101055 A1
(43) Pub. Date: May 5, 2011

(54) HEADREST HANGER

(76) Inventors: Thomas J. O'Neill, Lyndhurst, OH (US); Mary Jo O'Neill, Lyndhurst, OH (US)

(21) Appl. No.: 12/906,462

(22) Filed: Oct. 18, 2010

Related U.S. Application Data
(60) Provisional application No. 61/258,445, filed on Nov. 5, 2009.

(51) Int. Cl. B60R 7/00

(52) U.S. Cl. 224/275

(57) ABSTRACT

An apparatus for hanging clothes from a headrest of a motor vehicle includes a base and at least one strap that extends through a portion of the base and around the headrest. Each strap has a first end connected to a first fastening member and a second end connected to a second fastening member. The first and second fastening members are releasably engageable with one another to hold the base against the headrest. At least one hanging member is connected to the base and includes an interior space capable of receiving clothes hangers.

### RELATED APPLICATION

This application claims priority to U.S. Provisional Patent Application No. 61/258,445, filed Nov. 5, 2009, the subject matter of which is incorporated herein by reference in its entirety.

### TECHNICAL FIELD

The present invention relates to hangers and, in particular, relates to a clothes hanger for a headrest of a motor vehicle.

### BACKGROUND

Most vehicles include an OEM installed retractable hook that hangs from the ceiling of the interior of the vehicle for receiving coat hangers to hang clothes. Due to the position of the hooks, however, the clothes are typically positioned in front of the side windows of the vehicle adjacent to the rear passengers and sometimes directly behind the driver, which significantly impairs visibility through the rear of the vehicle. Furthermore, the OEM installed retractable hooks tend to be small and, thus, offer little space for hanging clothes. Moreover, clothes are sometimes positioned on the rear window sill, which also impairs driver visibility. Accordingly, efforts have been made to hang clothes off of the headrest of the vehicle in a position that does not impair the driver's visibility.

These headrest-mounted devices, however, are complex, intricate, and require significant assembly to function. Furthermore, the headrest-mounted hangers sometimes require alteration of the headrest and through use may wear upon the headrest over time. Accordingly, there is a need in the art for a device for hanging clothes from a headrest that is simple to use, offers significant storage space, and does not affect the appearance or lifespan of the headrest.

### SUMMARY OF THE INVENTION

In accordance with an embodiment of the present invention an apparatus for hanging clothes from a headrest of a motor vehicle includes a base and at least one strap that extends through a portion of the base and around the headrest. Each strap has a first end connected to a first fastening member and a second end connected to a second fastening member. The first and second fastening members are releasably engageable with one another to hold the base against the headrest. At least one hanging member is connected to the base and includes an interior capable of receiving clothes hangers.

In accordance with another aspect of the present invention an apparatus for hanging clothes from a headrest of a motor vehicle includes a base that extends along a vertical axis and includes a plurality of first openings positioned on a first side of the axis and a plurality of second openings positioned on a second side of the axis. A first strap extends through the plurality of first openings and a second strap extends through the plurality of second openings. Each strap has a first end secured to a first fastening member and a second end secured to a second fastening member. The first and second fastening members associated with each strap are releasably engageable with one another to hold the base against the headrest. Each strap extends through a hanging member to pivotally connect each hanging member to the base. Each hanging member includes an interior space capable of receiving clothes hangers.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of a vehicle headrest hanger in accordance with the present invention;

FIG. 2 is a side view of the hanger of FIG. 1;

FIG. 3 is a front view of a base plate of the hanger of FIG. 1;

FIG. 4 is a side view of a female fastener of the hanger of FIG. 1;

FIG. 5 is a side view of male fastener of the hanger of FIG. 1;

FIG. 6 is a schematic illustration of a strap of the hanger of FIG. 1;

FIG. 7 is a front view of a hanging member of the hanger of FIG. 1;

FIG. 8 is an exploded assembly view of the hanger of FIG. 1;

FIG. 9 is a front view of the headrest with the hanger of FIG. 1 secured thereto;

FIG. 10 is a rear view of the headrest of FIG. 9

FIG. 11 is a schematic illustration of the hanger of FIG. 9 with items connected thereto.

### DETAILED DESCRIPTION

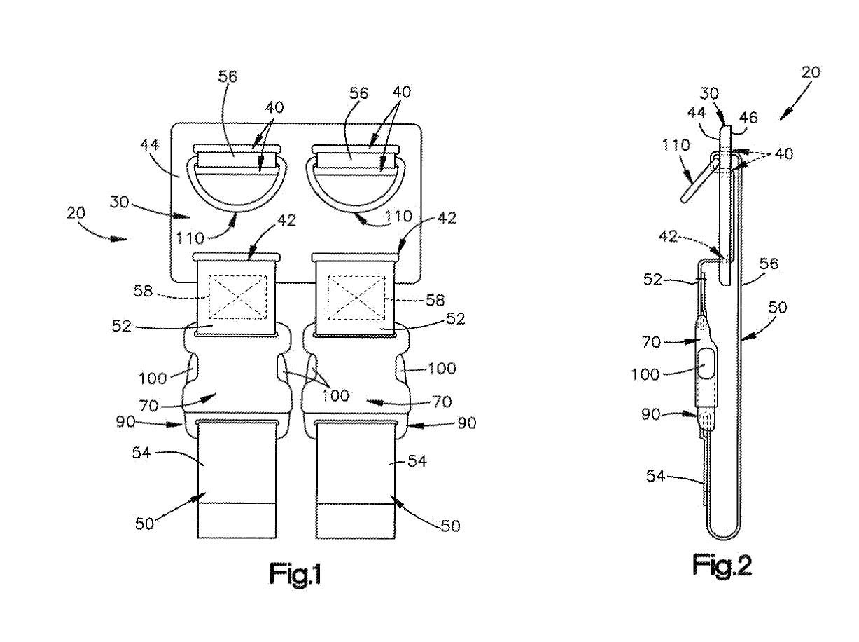

The present invention relates to hangers and, in particular, relates to a clothes hanger for a headrest of a motor vehicle. FIGS. 1-2 illustrate a clothes hanger 20 for a headrest of a motor vehicle in accordance with the present invention. The hanger 20 includes a base plate 30, a pair of straps 50, and cooperating fastening members 70, 90 associated with each strap for securing the base plate to the headrest.

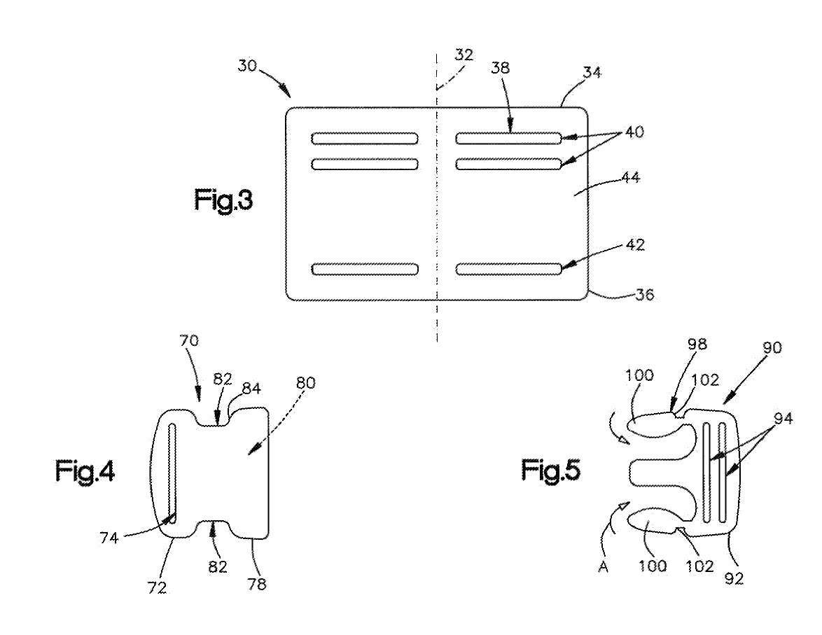

As shown in FIG. 3, the base plate 30 has a rectangular shape and may have a planar or arcuate contour to conform to the shape of a headrest of a motor vehicle. The base plate 30 may have rounded corners and/or edges to minimize wear and tear on the headrest. The base plate 30 is formed of a durable material, such as metal or plastic, and extends along an axis 32 from a first end 34 to a second end 36. The base plate 30 includes a front surface 44 and a rear surface 46 (see FIG. 2) that extends substantially parallel to the front surface. A pair of strap receiving portions 38 is formed in the base plate 30 for receiving the pair of straps 50. Each strap receiving portion 38 includes a plurality of first openings 40 and a single opening 42, although more or fewer first and/or second openings may be provided in accordance with the present invention. The first and second openings 40, 42 extend substantially perpendicular to the axis 32 of the base plate 30 and substantially parallel to one another. The first and second openings 40, 42 are similarly shaped and may constitute elongated slots having a shape configured to receive the strap 50. The first and second openings 40, 42 may be axially aligned with one another or may be offset from one another. Alternatively, the openings 40, 42 may be angled relative to one another (not shown). The edges of the base plate 30 defining the first and second openings 40, 42 may be rounded or dulled to remove sharp edges.

As shown in FIG. 3, a pair of strap receiving portions 38 is formed in the base plate 30 and positioned on opposite sides of the axis 32. The strap receiving portions 38 may be symmetrically or asymmetrically positioned about the axis 32 on the base plate 30. Although the strap receiving portions 38 are illustrated as openings formed in the base plate 30, those having ordinary skill will appreciate that the base plate may be provided with alternative or additional structure for receiving the straps 50, e.g., loops, hooks or U-shaped projections formed in or secured to the base plate.

Each of the two straps 50 has an elongated shape and extends from a first end 52 to a second end 54. A middle portion 56 connects the first end 52 to the second end 54. The strap 50 may be formed from a durable material such as nylon. Alternatively, the strap 50 may be made from an elastic material or have elastic portions. Each strap 50 is connected to a pair of fastening members 70, 90 for securing the base plate 30 to the headrest of the vehicle. Although FIGS. 1-3 illustrate a pair of straps 50 that extend through a corresponding pair of strap receiving portions 38 in the base plate 30, those having ordinary skill will appreciate that more or fewer straps may be provided and, thus, more or fewer corresponding strap receiving portions may be provided in the base plate in accordance with the present invention.

As shown in FIGS. 4-5, the fastening members 70, 90 may constitute male and female buckle portions that snap together. The fastening members 70, 90 may be made of plastic or other durable material. The first fastening member 70 includes a portion 72 for receiving the first end 52 of the strap 50, although the portion could likewise receive the second end 54 of the strap. The strap receiving portion 72 may include one or more openings 74 or other structure configured to accommodate the strap 50.

The first fastening member 70 further includes a portion 78 for receiving the second fastening member 90. The first fastening member receiving portion 78 may include a passage 80 that extends towards the strap receiving portion 72 and terminates at a pair of recesses 82 formed on opposing sides of the first fastening member 70. A stop surface 84 is associated with each recess 82 for preventing relative movement between the fastening members 70, 90 once the fastening members are connected to one another.

The second fastening member 90 includes a portion 92 for receiving the second end 54 of the strap 50. The strap receiving portion 92 may include an opening 94 or other structure configured to accommodate the strap 50 while allowing for relative movement between the strap and the second fastening member 90. The second fastening member 90 includes structure 98 that releasably engages the first fastening member 70. The structure 98 may include a plurality of resiliently deflectable tabs 100 that extend from the strap receiving portion 92. The tabs 100 are configured to mate with the recesses 82 of the first fastening member 70 and are elastically movable in the direction indicated by arrow A. Each tab 100 includes a retaining surface 102 that engages the stop surface 84 on the first fastening member 70 to prevent relative movement between the fastening members 70, 90. Although the fastening members 70, 90 are illustrated as portions of a buckle, those having ordinary skill will appreciate that the fastening members could constitute any structure that releasably cooperates to secure the ends 52, 54 of the strap 50 together. For example, the fastening members 70, 90 may include Velcro®, hooks, adhesive portions, magnetic portions or the like. In any case, the configuration of the fastening members 70, 90 allows the fastening members to be secured to one another in a simple manner without the need for extra tools.

As shown in FIG. 7, the hanging members 110 may constitute rings or loops having a configuration suitable for receiving a plurality of clothes hangers. Each hanging member 110 may have a D-shaped configuration that includes a straight portion 112 and an arcuate portion 114. Alternatively, the hanging members 110 may have other shapes, such as oval, circular, triangular or any other polygonal shape. In any case, the shape of the hanging member 110 defines an interior space 116 capable of receiving at least one hook, such as the end of a coat hanger (not shown). The hanging members 110 are made from a durable material such as metal or plastic.

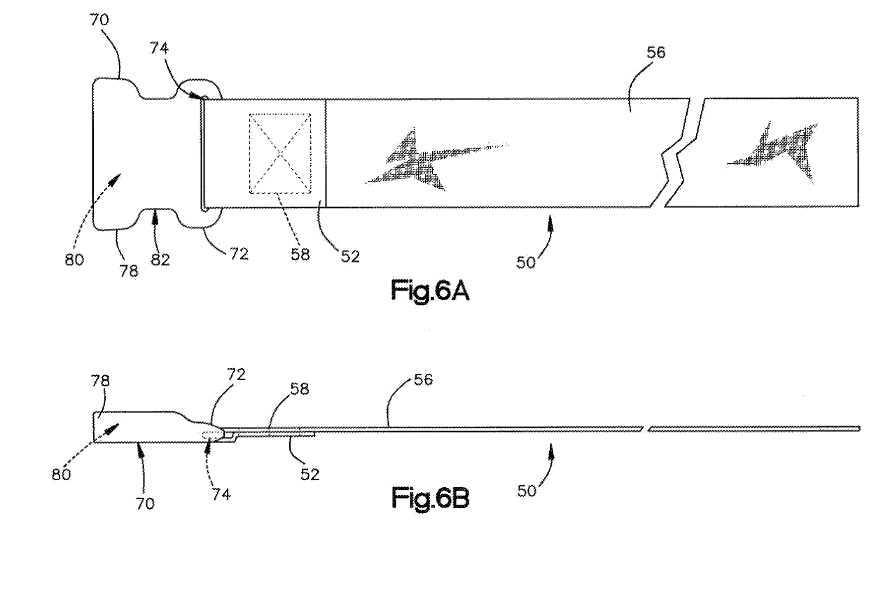

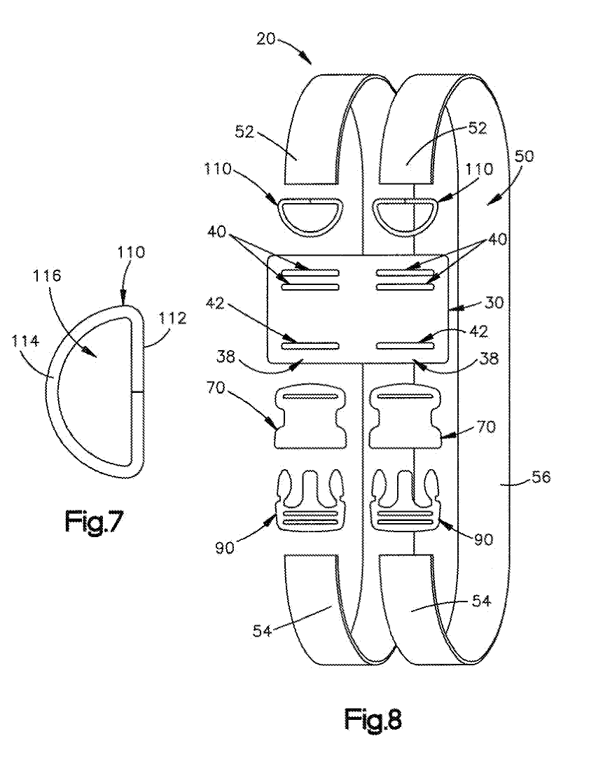

To assemble the hanger 20 of the present invention, the first end 52 of the strap 50 is fed through the openings 74 in the strap receiving portion 72 of the first fastening member 70. The first end 52 of the strap 50 is then secured to the middle portion 56 of the strap to via stitches 58 or the like to encircle the strap receiving portion 72 such that the position of the first fastening member 70 along the strap becomes fixed or substantially fixed (FIG. 6). The second end 54 of the strap 50 is then fed from the front surface 44 of the base plate 30 through the second opening 42 in the base plate, along the rear surface 46, and through the first opening 40 closest to the second opening 42 in the base plate.

The straight portion 112 of the hanging member 110 is then positioned between the first openings 40 of the strap receiving portion 38 on the front surface 44 of the base plate 30 such that the curved portion 114 extends away from the second opening 42 in the base plate. The second end 54 of the strap 50 is then fed back through the interior space 116 of the hanging member 110 and the remaining first opening 40 to pin the hanging member between the strap and the base plate 30. Due to the connection between the strap 50, the base plate 30, and the hanging member 110, the hanging member is pivotable relative to the strap and the base plate. The second end 54 of the strap 50 is then pulled though the first and second openings 40, 42 until the first fastening member 70 is positioned adjacent to the second end 36 of the base plate 30. This places the first end 52 of the strap 50 in a substantially s-shaped configuration relative and through the base plate 30 (FIG. 2).

The second end 54 of the strap 50 is then fed through the opening 94 in the strap receiving portion 92 of the second fastening member 90. The second end 54, however, is not secured to the middle portion 56 of the strap 50 such that the second end of the strap is movable through and relative to the second fastening member 90 to adjust the position of the second fastening member along the length of the strap. The process of connecting the fastening members 70, 90 to the strap 50 and feeding the strap through the corresponding strap receiving portion 38 in the base plate 30 to pivotally secure a hanger member 110 to the base plate is repeated for each strap if more than one strap is provided.

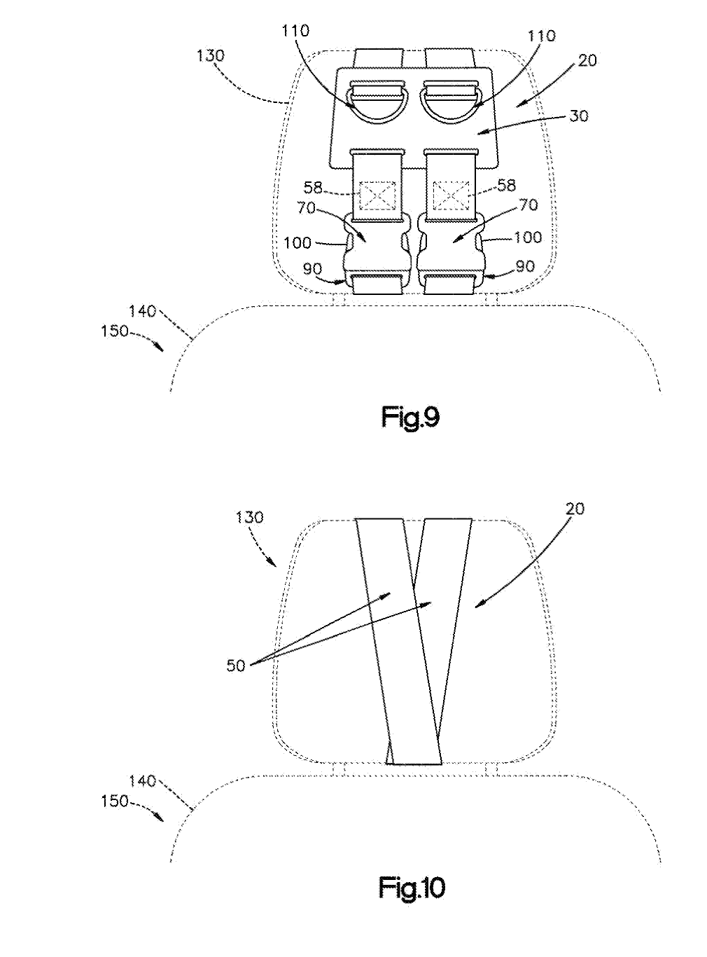

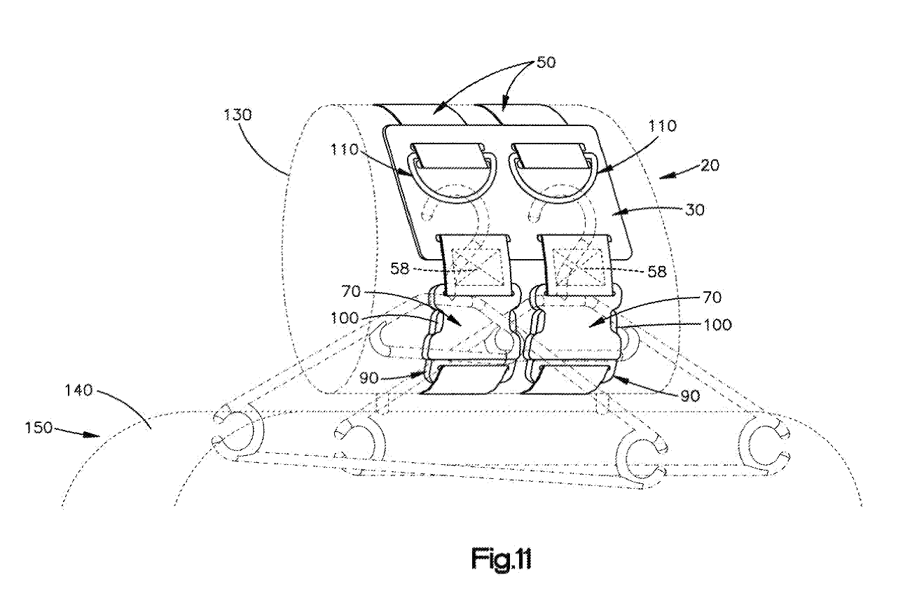

FIG. 9 illustrates the assembled hanger 20 secured to a headrest 130 connected to the back portion 140 of a vehicle seat 150. Once all the straps 50 and hanging members 110 are connected to the base plate 30, the base plate is positioned against the back &the headrest 130 facing the rear of the vehicle such that the hanging members are visible. The middle portion 56 of each strap 50 is then wrapped around the headrest 130 such that the second end 54 of the strap 50 is placed in close proximity with the first end 52 of the strap 50 and, thus, the fastening members 70, 90 are positioned in close proximity with one another. If necessary, the headrest 130 is raised or lowered to facilitate wrapping the straps 50 around the headrest. The straps 50 may be wrapped around the headrest 130 in the crossed manner shown in FIG. 10 or may extend parallel to one another around the headrest (not shown).

Each male or second fastening member 90 is then inserted into the corresponding female or first fastening member 70 such that all of the fastening members are snapped or held together. In this configuration, the straps 50 form closed loops around the headrest 130. More specifically, the straps 50 and fastening members 70, 90 cooperate to completely vertically encircle the headrest 130. The exposed second end 54 of the strap 50 may then be pulled to move the second end relative to the second fastening member 90 to constrict the strap to the contour of the headrest 130. Since the base plate 30 conforms to the headrest and is held against the headrest 130 by the tightened straps 50, the hanger 20 of the present invention forms a low profile, secure connection with the headrest.

The connection between the base plate 50 and the hanging members 110 also contributes to the low profile of the hanger 20. As shown in FIG. 2, since the hanging members 110 are pinned against the base plate 50, the base plate and hanging members are substantially positioned within the same plane. When the hanger 20 is secured to the headrest, this common plane extends in the vertical direction.

Once the hanger 20 is secured to the headrest 130, one or more items may be suspended from the hanging members 110 of the hanger by clothes hangers, etc., as shown in FIG. 11. The arcuate profile of the hanging members 110 allows for a large number of items, e.g., clothes, groceries, etc., to be hung from the headrest 130 in a low profile manner without obstructing the windows or driver's line of sight. The hook ends of, for example, coat hangers may be fed through the interior space 116 of each hanging member 110 and hooked onto the arcuate portion 114 of hanger members to hang clothes from the hanger 20. Due to the configuration of the hanger 20 and, in particular, the low profile of the base plate 30 and the hanging members 110, clothes hung from the hanger are positioned close to the rear side of the back portion 140 of the vehicle seat 150, thereby providing passengers with more space behind the vehicle seat for ingress and egress.

The hanger 20 of the present invention is advantageous over prior headrest devices due to its compact profile and versatility. In particular, since the lengths of the straps 50 may be adjusted, the hanger 20 of the present invention may be quickly adjusted to accommodate a headrest 130 of any size or shape. The size and shape of the base plate 30, the width and length of the straps 50, the type of fastening members 70, 90 used, and the configuration of the hanging members 110 may all be adjusted or tailored to accommodate a particular headrest 130 and/or particular items to be hung from the hanger 20.

The hanger 20 is also advantageous in that the engagement maintained between the headrest 130 and the base plate 30 provides a reaction force against impacts upon the hanger 20. Additionally, by positioning the hanging member 110 behind the headrest 130, items hung from the hanger 20 of the present invention are positioned out of the view of the driver and away from the windows of the vehicle, thereby increasing driving visibility. Moreover, the hanger 20 of the present invention minimizes wear on the headrest 130 by eliminating sharp corners on the base plate 30, and the straps 50 are sized to widely distribute the tensioning forces upon the headrest, thereby reducing stress concentrations on the headrest. The position of the hanging members 110 overlying the base plate 30 also reduces wear on the headrest 130 because hangers or hooks extending through the hanging members engage the base plate instead of the headrest.

The preferred embodiments of the invention have been illustrated and described in detail. However, the present invention is not to be considered limited to the precise construction disclosed. For example, although the hanger 20 of the present invention is illustrated as extending vertically around the headrest, those having ordinary skill will contemplate that the hanger could likewise extend horizontally or at an angle relative to and around the headrest. Various adaptations, modifications and uses of the invention may occur to those skilled in the art to which the invention relates and the intention is to cover hereby all such adaptations, modifications, and uses which fall within the spirit or scope of the appended claims.

Having described the invention, the following is claimed:

1. An apparatus for hanging clothes from a headrest of a motor vehicle comprising:
a base;
at least one strap extending through a portion of the base and around the headrest, each strap having a first end connected to a first fastening member and a second end connected to a second fastening member, the first and second fastening members being releasably engageable with one another to hold the base against the headrest; and
at least one hanging member connected to the base and including an interior space capable of receiving clothes hangers.

2. The apparatus of claim 1, wherein the strap extends through the hanging member and a portion of the base to pivotally connect the hanging member to the base.

3. The apparatus of claim 1, wherein the hanging member comprises a loop having a curved portion for receiving clothes hangers.

4. The apparatus of claim 3, wherein the loop further comprises a straight portion over which the strap extends for pivotally connecting the hanging member to the base.

5. The apparatus of claim 1, wherein the hanging member has a D-shaped configuration.

6. The apparatus of claim 5, wherein the second end of the strap is slidably received in the second fastening member for adjusting the length of the strap extending between the first and second fastening members to conform the contour of the strap to the contour of the headrest.

7. The apparatus of claim 1, wherein the at least one strap comprises a first strap extending through a plurality of first openings in the base and a second strap extending through a plurality of second openings in the base.

8. The apparatus of claim 7, wherein the first strap and the second strap have a first configuration relative to one another on a first side of the headrest and a second, different configuration relative to one another on a second side of the headrest.

9. The apparatus of claim 8, wherein the first configuration is a parallel configuration and the second configuration is a crossed configuration.

10. The apparatus of claim 1, wherein the first and second fastening members and the straps cooperate to completely vertically encircle the headrest.

11. The apparatus of claim 1, wherein the first and second fastening members comprise male and female buckle portions.

12. The apparatus of claim 1, wherein the at least one strap extends through at least one horizontal opening in the base.

13. The apparatus of claim 1, wherein the at least one hanging member overlies the base.

14. The apparatus of claim 1, wherein the base is contoured to the shape of the headrest.

15. The apparatus of claim 1, wherein the base and the at least one hanging member are substantially positioned within the same vertical plane when the base is secured to headrest.

16. An apparatus for hanging clothes from a headrest of a motor vehicle comprising:
a base extending along a vertical axis and including a plurality of first openings positioned on a first side of the axis and a plurality of second openings positioned on a second side of the axis;
a first strap extending through the plurality of first openings; and
a second strap extending through the plurality of second openings, each strap having a first end secured to a first fastening member and a second end secured to a second fastening member, the first and second fastening members associated with each strap being releasably engageable with one another to hold the base against the headrest;
wherein each strap extends through a hanging member to pivotally connect each hanging member to the base, each hanging member including in interior space capable of receiving clothes hangers.

17. The apparatus of claim 16, wherein each hanging member has a D-shaped configuration.

18. The apparatus of claim 17, wherein each strap extends through the associated openings in the base to pin the hanging member between the strap and the base to pivotally connect the hanging member to the base.

19. The apparatus of claim 16, wherein the length of the strap is adjustable such that the fastening members and strap cooperate to completely vertically encircle the headrest.

20. The apparatus of claim 16, wherein the plurality of first openings and the plurality of second openings comprise horizontal slots in the base.
